(19) United States
(12) Patent Application Publication
(10) Pub. No.: US 2026/0230734 A1
(43) Pub. Date: Aug. 6, 2026

(54) GRILLE FOR AN ACOUSTIC TRANSDUCER

(71) Applicant: B & W GROUP LTD, Worthing Sussex (GB)

(72) Inventors: Karol Bugaj, SOUTHWATER (GB); Simon Matthews, London (GB); Jonathan David Bleasby, Horsham (GB); Paul Thomas Harris, London (GB)

(21) Appl. No.: 19/150,162

(22) PCT Filed: Jan. 22, 2024
(86) PCT No.: PCT/US2024/012447

§ 371 Date: Jul. 22, 2025

Related U.S. Application Data
(60) Provisional application No. 63/481,150, filed on Jan. 23, 2023.

(30) Foreign Application Priority Data
Jan. 23, 2023 (GB) 2300981.4

(51) Int. Cl. H04R 1/02; H04R 1/24; H04R 31/00

(52) U.S. Cl. CPC H04R 1/023; H04R 1/24; H04R 31/00

(57) ABSTRACT

A grille (102) for an acoustic transducer unit for example a tweeter has an arrangement of apertures such that when projected onto a notional flat surface there is a pattern of holes (104) formed by a repeating tessellating cell (106). The repeating cell comprises a hole of a first shape (114) and a hole of a second shape (116). The second shape (116) may have a convex region that faces a concave region (128) of the first shape (114). At least one of the shape, size and orientation of the first shape may be different from that of the second shape. Adjacent holes in the pattern are separated from each other by one or more walls (112), which may extend along a non-linear path between the holes.

### CROSS-REFERENCE TO RELATED APPLICATIONS

This application claims the benefit of U.S. Provisional Patent Application No. 63/481,150, filed Jan. 23, 2023, and titled GRILLE FOR AN ACOUSTIC TRANSDUCER. The application also claims priority to UK Patent Application No. 2300981, filed Jan. 23, 2023, and titled GRILLE FOR AN ACOUSTIC TRANSDUCER. The entirety contents of each of the above-identified applications are hereby incorporated by reference herein and made part of this specification for all that they disclose.

### BACKGROUND

### Field of the Disclosure

The present disclosure concerns a grille for an acoustic transducer. More particularly, but not exclusively, this disclosure concerns a loudspeaker grille, such as for use with a speaker driver (e.g. a tweeter unit) that forms part of a loudspeaker (e.g., a hi-fi loudspeaker). The disclosure also concerns a method of making such a loudspeaker grille.

### Description of the Related Art

A loudspeaker grille for a loudspeaker, such as a high-end hi-fi loudspeaker, typically performs the function of protecting a loudspeaker diaphragm from damage while attempting to avoid or minimize adverse effects on the quality of reproduction of sound emitted by the loudspeaker. Although various loudspeaker grilles are known, there remains a need for improved loudspeaker grilles.

The present disclosure seeks to provide improved grilles, such as a high performing grille for an acoustic transducer, as an alternative to those currently forming the state of the art. The present disclosure alternatively or additionally seeks to provide an improved grille for an acoustic transducer, particularly an improved tweeter grille.

### SUMMARY

Certain example embodiments are summarized below for illustrative purposes. The embodiments are not limited to the specific implementations recited herein. Embodiments may include several novel features, no single one of which is solely responsible for its desirable attributes or which is essential to the embodiments. the grille having an arrangement of apertures such that when projected onto a notional flat surface there is a pattern of at least 20 holes (possibly at least 50 holes or more and optionally at least 150 holes, or any values or range therebetween). The pattern is formed by a repeating tessellating cell comprising at least one hole being a first shape (referred to below as the first hole) and at least one hole being a second shape (referred to below as the second hole), the tessellating cells tessellate in adjacent straight lines. According to a first aspect of the disclosure, the second shape can have a convex region that faces a concave region of the first shape.

It has been found that the embodiments, when applied to a tweeter grille for example, have performed better than other types of comparable grilles. Although not limited by theory, this is thought to be as a result of the shapes of the holes used in the tessellating pattern and the arrangement of the structure between the holes. The structure (e.g., mesh) that defines the apertures/holes can have sufficient structural integrity that it provides physical protection against inadvertent damage to the acoustic transducer, while being sufficiently open (e.g., a high enough sum area of holes per unit area) that there is sufficiently good transmissibility of sound waves through the grille across the frequency band of operation. It may be that having holes with a concave portion enables more complicated patterns than proposed by the prior art which therefore have the capacity for improved performance. The pattern being such that convex region of the second shape faces the concave region of the first shape may enable more efficient use of material (e.g. less material per unit area) and/or larger apertures/holes per unit area.

The apertures in the 3-D grille (corresponding to the holes in the 2-D pattern) can be defined by structure that surrounds the apertures (holes). The structure may be referred to as a mesh. The mesh may be considered as being formed solely by walls, the walls being what defines the apertures (holes). In three-dimensions, the tweeter grille can have walls and apertures (corresponding to the holes, but possibly with a slightly deformed shape as a result of the transformation to a 3-D shape). The pattern of holes (and walls) is mostly referred to herein in the context of the two-dimensional pattern formed by a projection onto a notional flat surface (e.g., which essentially preserves the shapes and relative arrangement of the 3-D pattern of apertures). The projection may be a mathematical projection, used to transform a 3-D pattern into a 2-D pattern, such as one approximating a stereographic projection. If there is a repeating pattern of shapes, albeit with distortion of the like, in the 3-D grille, then the projection pattern of apertures in 3-D is mapped onto an identically configured tessellating cell, with each cell having an arrangement of holes that corresponds to a stereographic projection of the pattern of apertures closest to the center of the grille.

It may be that the first hole is a different shape from the second hole. The first hole may be a different size from the second hole, for example having an area that is different, for example greater than the second hole. The first hole may have an orientation different from the second hole, for example having the same shape but being rotated to a different angular position.

It may be that the first hole has a first area and a first orientation and the second hole has a second area and a second orientation, such that at least one of the shape, size and orientation of the first hole is different from the corresponding shape, size and orientation of the second hole. The first shape may have a larger area than the second shape, for example an area that is at least twice as large, preferably at least about 5 times larger, about 7 times larger, or possibly more than about 10 times the area of the second shape, or any values or ranges therebetween. In some embodiments, the area of the first shape is at least about 17.5 times as large (but possibly no greater than about 30 times as large, and possibly in the range from about 10 to about 25 times greater) as the area of the second shape. The second shape may have an area that is larger than about 3% of the area of the first shape. The second shape may have an area that is about 2%, about 3%, about 4%, about 5%, about 7%, about 10%, about 15%, or about 20% of the area of the first shape, or any values or ranges between these percentages, although other designs are possible. The area of the smallest hole in the repeating cell may be greater than about 0.1 mm². The area of the second shape may be greater than about 0.1 mm², optionally greater than about 0.15 mm² (and possibly no greater than about 1 mm²), or any values or ranges therebetween. The area of the largest hole in the repeating cell may be greater than about 2 mm², optionally greater than about 3 mm² (possibly greater than about 4 mm² and/or possibly no greater than about 10 mm²). The area of the first shape may be greater than 2 mm², optionally greater than 3 mm² (possibly greater than 4 mm² and/or possibly no greater than 10 mm²), or any values or ranges therebetween. The largest hole in the repeating cell may have the same area as the first shape (they may be the same hole). The smallest hole in the repeating cell may have the same area as the second shape (they may be the same hole). of the holes expressed as a percentage of the total area of the cell) may be greater than about 50%, optionally between about 50% and about 70%, such as about 50%, about 55%, about 60%, about 65%, about 70%, about 75%, or more, or any values or ranges therebetween, although other designs could be used. It is preferred that the pattern of holes in the cell as designed (i.e. before manufacturing, so before etching, machining, applying coatings of the like) has an open area that is greater than about 57% by the pattern, optionally about 58% or greater. The walls may have a width that at its narrowest is greater than about ¼ mm, preferably greater than about ⅓ mm (and possibly less than about 2 mm, optionally less than about 1 mm), or any values or ranges between any of these values, although other designs are possible.

It may be that the pattern includes walls such that adjacent holes in the pattern are separated from each other by one of the walls. The presence of concave regions and corresponding convex regions may mean that a wall that extends between such regions, and optionally from and/or to other parts of the pattern, extends along a non-linear path. Additionally, or alternatively, there may be a wall (e.g. one of substantially constant width) which extends along a non-linear path between a concave region and a corresponding convex region, thereby defining the shape of the concave region and the corresponding convex region. It may be that having walls that do not follow straight lines (when viewed as the 2-D pattern) allows for improved acoustic performance.

It may be that the pattern includes walls such that adjacent holes in the pattern are separated from each other by one of the walls. The walls may extend along a non-linear path between the holes. The walls can each have a minimum width. It may be that the walls are so configured that (in the 2-D pattern) it is not possible to identify three straight lines such that (a) each straight line has a constant width being about 75% of the minimum width of the wall (or optionally about 50% or optionally about 85% of the minimum width of the wall, or any values or ranges therebetween), (b) each straight line extends completely through at least three cells, (c) each straight line is angled apart from each of the other two straight lines by more than about 30 degrees, and (d) each straight line is wholly contained within the boundaries of a wall. In other words, there are at least some walls in the pattern that deviate significantly from a straight line path. While some meshes have a 2-D pattern of holes such that there are non-straight lines, such patterns are typically observed in meshes where the shapes forming the holes are all the same shape, lines (e.g. radial/circular patterns of holes).

It may be that some embodiments of the disclosure have benefit where the walls are non-linear but where the first shape of hole of the pattern of tessellating cells does not necessarily have any concave regions facing a convex region of a second shape of hole. Thus, according to a second aspect of the disclosure, the hole of the first shape has a first area and a first orientation and the hole of the second shape has a second area and a second orientation, wherein at least one of the shape, size and orientation of the first shape is different from the corresponding shape, size and orientation of the second shape, and wherein the pattern includes walls such that adjacent holes in the pattern are separated from each other by one of the walls, the walls each having a minimum width and extending along a non-linear path between the holes, such that it is not possible to identify three straight lines such that (a) each straight line has a constant width being about 75% of the minimum width of the wall, (b) each straight line extends completely through at least three cells, (c) each straight line is angled apart from each of the other two straight lines by more than about 30 degrees, and (d) each straight line is wholly contained within the boundaries of a wall.

The following description corresponds to features of the first and/or second aspects of the disclosure, and it will be appreciated that features described in relation to one aspect may be applied to the other aspect.

The tessellating cell may comprise the smallest number of holes that enable a tessellation.

It may be that the tessellating cells tessellate in adjacent straight lines, for example such that the cells are staggered as between adjacent lines. It may for example be that every other adjacent straight line of cells have cells that are aligned. The tessellating cell may be in the shape of a diamond (rhombus). It will be understood that the tessellating cell comprises only whole holes (no partial holes).

The first shape may have six fold symmetry. It may be that the first shape has at least three concave regions (six for example) each of which face a corresponding convex region of a second shape in the pattern. The first hole may have the general form of an 18-sided polygon with six outer sides being tangents to a notional circle and equally spaced apart, each of the six outer sides being joined to the next outer side by two sides which meet inwardly of the notional circle at an angle of between about 100 and about 140 degrees (in some cases between about 110 and about 130 degrees) to rounded to avoid sharp corners and optionally with each side being substantially the same size (e.g., +/−50% of the average size). The rounding of corners may be such that no portion of the perimeter of a corresponding aperture in the grille has a radius of curvature smaller than about 0.1 mm (for example the rounding having a radius of curvature of between about 1/10 and about ¼ of a millimeter). The rounding of corners of the shape of holes/apertures in the grille may be, at least in part, formed as a result of adding one or more coatings to an otherwise less rounded corner.

It may be that each cell comprises at least three holes, for example one first shape and at least two second shapes. The number of holes in a cell may be fewer than ten, optionally five or fewer. Some embodiments may have only three holes per cell, and only two different shapes (e.g. a large first shape and two smaller second shapes).

The grille may be made from a sheet of material, for example one with apertures formed in it when flat and which is then bent into shape. The sheet material may have a substantially constant thickness, before and/or after being bent into shape for example. The thickness of the sheet (and therefore the thickness of the walls of the mesh, for example) may be about 0.1 mm or more, and in some cases at least about 0.2 mm. The thickness of the sheet may be about 2 mm or less, and in some cases about 1 mm or less. The grille (e.g., when forming a grille for a tweeter) may have a maximum dimension (typically its diameter) of about 100 mm or less, for example between about 25 mm and about 80 mm, although other sizes are possible.

The grille may be dome-shaped or comprise a dome-shaped part, for example having a generally round profile when viewed from the front. The dome-shaped part of the grille is referred to as the dome. The center of the dome may coincide with a hole of the first shape, particularly when the first shape is larger than the second shape. The dome may have a depth of at least about 10 mm, and optionally between about 10 mm and about 30 mm. In such a case, the radius of curvature, at its lowest, of the dome, may be in the range of about 10 mm to about 50 mm. In some embodiments, the dome may have a shallower profile, for example having a radius of curvature, at its lowest, of the dome, may be in the range of about 50 mm to about 100 mm. In such a case the grille may have a lip, for example being a cylindrical flange that extends rearward of the rearmost part of the dome-shaped part of the grille. The depth of the dome-shaped part may be in the range from about 2 mm to about 10 mm. The depth of the lip may be in the range from about 5 mm and about 20 mm.

The grille may be differently sized to suit different applications. The grille may be used on midrange or bass drive units. The grille is preferably configured for use in respect of an acoustic transducer unit that is a hi-fi quality drive unit for a hi-fi loudspeaker. The loudspeaker grille could be used for a headphone application for example, in which case the grille may be relative flat. In a case where the grille is already flat, it will be appreciated that the arrangement of apertures (in 3-D) may be the same as the pattern of holes (in that projecting onto a notional flat surface is redundant as a result of the, already flat, pattern being the same in 3-D and 2-D).

The first hole may be generally round in shape. The first hole can have a perimeter which defines the boundary of the hole in 2-D. The first hole may have a maximum diameter and a corresponding maximum radial distance from a center of the hole to the perimeter of the hole. The first hole may have a minimum diameter and a corresponding minimum radial distance from a center of the hole to the perimeter of the hole. It may or may not be the case that the maximum diameter is exactly twice the maximum radial distance and/or that the minimum diameter is exactly twice the minimum radial distance. The first hole may be generally round in shape in the sense that it is not elongate and/or is not pointy, like a pointed star. For example, the maximum diameter of the first hole may be no more than about 60% bigger (in some cases being between about 10% and about 50% bigger) than the minimum diameter of the first hole. It may be that at least 20% of the length of the perimeter of the first hole is at a distance of at least 90% of the maximum radial distance from the center of the hole. It may be that at least 20% of the length of the perimeter of the first hole is at a distance of at least 95% of the maximum radial distance from the center of the hole. It may be that at least 50% of the perimeter is at a distance of at least 85% of the maximum radial distance from the center of the hole. It may be that about 15%, about 20%, about 25%, about 30%, about 40%, about 50%, about 60%, about 70%, or more (included any values or ranges therebetween) of the length of the perimeter of the first hole is at a distance of at least 95% of the maximum radial distance from the center of the hole. It may be that about 30%, about 40%, about 50%, about 60%, about 70%, about 80%, or more (included any values or ranges therebetween) of the perimeter is at a distance of at least 85% of the maximum radial distance from the center of the hole. 35%, about 40%, about 45%, about 50%, about 55%, about 60%, about 65%, about 70%, or more (included any values or ranges therebetween) of the length of the perimeter of the first hole is at a distance of at least 95% of the maximum radial distance from the center of the hole. It may be that about 15%, about 20%, about 25%, about 30%, about 40%, about 45%, about 50%, about 55%, about 60%, about 65%, about 70%, or more (included any values or ranges therebetween) of the length of the perimeter of the first hole is at a distance of at least 90% of the maximum radial distance from the center of the hole. It may be that about 30%, about 35%, about 40%, about 45%, about 50%, about 55%, about 60%, about 65%, about 70%, about 75%, about 80%, or more (included any values or ranges therebetween) of the perimeter is at a distance of at least 85% of the maximum radial distance from the center of the hole.

The second hole may be a generally round shape, for example, having a minimum diameter and a maximum diameter, the maximum diameter being no more than about 30% bigger (in some cases being less than about 20% bigger) than the minimum diameter. The second hole may be a rounded hexagonal shape for example. The second hole can have a maximum diameter that is about 10%, about 15%, about 20%, about 25%, or about 30% larger than its minimum diameter, or any values or ranges therebetween.

There may be at least 300, and possibly 500 apertures or more, in total in the grille (the apertures each corresponding to a hole of the pattern that is formed by the repeating tessellating cells). The grille may be configured such that there are at least 100, optionally at least 150 and possibly more than 200 holes of the first shape. The (2-D) pattern of holes may be shaped such that a notional circle can be drawn around at least 50 holes such that for any chosen 90 degree arc of the circle, the circle crosses a hole.

As mentioned above, the grille may be an acoustic grille for use on a variety of differently sized hi-fi applications. The grille may be of particular benefit when in the form of a grille for a tweeter loudspeaker. In such case, the grille may have a diameter of between about 30 mm and about 100 mm, for example between about 40 mm and about 80 mm.

The grille may be attached to drive unit for a hi-fi loudspeaker, for example a tweeter drive unit. The present disclosure thus further provides a tweeter drive unit to which is attached a grille according to any aspect of the present disclosure as described herein. The tweeter drive unit may be a hi-fi tweeter drive unit for use in, or coated or diamond dome tweeter. The tweeter unit may have its own body and/or its own dedicated housing.

The present disclosure yet further provides a hi-fi loudspeaker comprising a tweeter drive unit according to any aspect of the present disclosure as described herein. The hi-fi loudspeaker may comprise an enclosure which houses a midrange loudspeaker driver and/or bass loudspeaker driver. The same enclosure may house the tweeter drive unit. The tweeter unit (which may have its own body) may alternatively be mounted on top of the enclosure of the loudspeaker.

There is also provided a method of making a loudspeaker grille (for example, for a tweeter unit) comprising bending or otherwise deforming a sheet of metal (e.g. a flat sheet of metal) to form a dome-shaped region, wherein the sheet of metal is one in which a pattern of at least 20 holes are formed in accordance with any aspect of the present disclosure as described herein. The pattern of holes may be machined from the sheet, for example by cutting, drilling or other machining techniques. The pattern of holes may be formed in the sheet by forming the sheet with the holes, for example by a moulding technique, additive manufacturing (e.g. 3-D printing) or similar methods.

It will of course be appreciated that features described in relation to one aspect of the present disclosure may be incorporated into other aspects of the present disclosure. For example, the disclosed method may incorporate any of the features described with reference to the disclosed apparatus and vice versa.

### BRIEF DESCRIPTION OF THE DRAWINGS

Certain embodiments will be discussed in detail with reference to the following figures, wherein like reference numerals refer to similar features throughout. These figures are provided for illustrative purposes and the embodiments are not limited to the specific implementations illustrated in the figures. Embodiments of the present disclosure will now be described by way of example only with reference to the accompanying schematic drawings of which:

FIGS. 1 to 7 are various schematic drawings showing aspects of tweeter grilles;

FIG. 8 shows a pattern of holes of a mesh for a tweeter grille according to a first embodiment; and

FIG. 9 shows a part of the pattern of FIG. 8;

FIG. 10 shows a single hole of the pattern of FIG. 8; according to the first embodiment;

FIG. 12 shows the tweeter unit of FIG. 11;

FIG. 13 is a side view of the grille of the first embodiment;

FIG. 14a is a −6 dB frequency response contour plot comparing the performance of a tweeter unit according to the first embodiment using the pattern of FIG. 8 with a tweeter unit using the pattern of FIG. 5;

FIG. 14b is a −1.76 dB contour plot comparing the performance of the tweeter unit according to the first embodiment using the pattern of FIG. 8 with the tweeter unit using the pattern of FIG. 5;

FIG. 15 is a contour plot of sound pressure showing the performance of a tweeter unit according to an example that uses the pattern of FIG. 5 with varying frequency and position of measurement (by angle) for comparison with FIG. 16;

FIG. 16 is a plot similar to FIG. 15 but showing the performance of a tweeter unit according to the first embodiment that uses the pattern of FIG. 8;

FIG. 17 is power spectrum plot from 3 kHz to 6 kHz comparing the performance of a tweeter unit according to the first embodiment that uses the pattern of FIG. 8 with a tweeter unit that uses the pattern of FIG. 5;

FIG. 18 is power spectrum plot covering 20 kHz to 35 kHz comparing the performance of a tweeter unit according to the first embodiment that uses the pattern of FIG. 8 with a tweeter unit that uses the pattern of FIG. 5;

FIG. 19 shows a loudspeaker incorporating a tweeter unit and a grille also used to test the grille of the embodiment that used the pattern of FIG. 8;

FIGS. 20 to 37 show variations of patterns of holes according to further embodiments (18 different patterns in total, so from a second embodiment to a 19th embodiment);

FIG. 38 shows an example of how a 3-D pattern of apertures may be projected as a pattern of holes on a flat 2-D surface;

FIG. 39 shows a loudspeaker incorporating a tweeter unit and a grille according to a 20th embodiment;

FIG. 40 shows is a side view of the grille of the 20th embodiment; and

FIG. 41 is a flow chart illustrating the step of making a loudspeaker according to a 21st embodiment.

The various features and advantages of the systems, devices, and methods of the technology described herein will become more fully apparent from the following description of the examples illustrated in the figures. These examples are intended to illustrate the principles of this disclosure, and this disclosure should not be limited to merely the illustrated examples. The features of the illustrated examples can be modified, combined, removed, and/or substituted as will be apparent to those of ordinary skill in the art upon consideration of the principles disclosed herein.

It may be that a loudspeaker grille can affect at least some aspects of the quality of reproduction of sound. Some aspects of the quality of reproduction of sound can be assessed by making objective measurements regarding the performance of a loudspeaker, for example when operated with an amplified test signal in an anechoic chamber. Some aspects of the quality of reproduction of sound can be assessed by a panel of suitably qualified listening experts who can make comparative judgements as between the performance of a set-up of one kind versus a set-up of a different kind. Quality may for example be measured or compared using a combination of such assessments. The performance of a loudspeaker grille may be judged on the clarity of reproduction across the whole audible spectrum, perceived resolution of sound, and imaging of sources across the sound stage (accuracy of stereo sound reproduction), as well as other factors. When judging the quality of sound reproduced by a tweeter and its associated grille there can generally be a focus on higher frequencies within the audible range, and how bright or lively the sound reproduction is. The quality as perceived by a listener, or group of listeners, and the objective assessments able to be made with acoustic measuring equipment, may both be used to assist in the design and manufacture of audio equipment (e.g., hi-fi audio equipment), such as tweeters and their grilles.

A loudspeaker grille, particularly for a tweeter, may often have a curvature so as to define a partly spherical or dome-shaped form, typically presenting a concave shape when view from the front of the tweeter (looking towards the sound-emitting front of the tweeter).

A loudspeaker grille can be designed to have a level of acoustic transparency yet provide sufficient protection from accidental damage to the loudspeaker underneath. Without adequate protections, such accidental damage may be caused by impact with an object or person, being poked by a finger for example, or by an overly inquisitive domestic pet. Grilles may be formed by a fabric. In some cases, such as with freely pass therethrough. The mesh may be a relatively rigid structure formed by solid material that defines the apertures. It may be the case that the mesh is initially made as a flat structure and then bent/stretched/deformed to the desired 3-D shape.

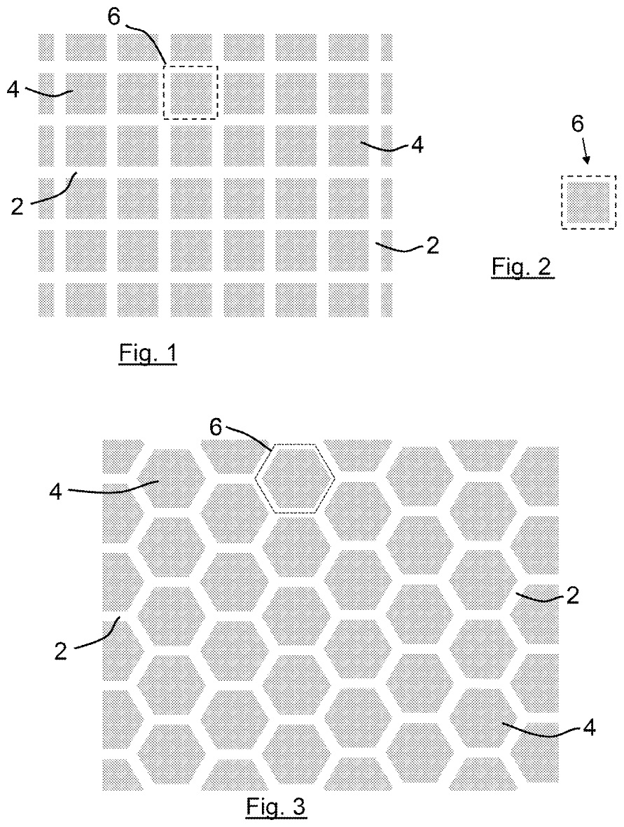

Various patterns of mesh can be used as the basis of the pattern for a loudspeaker (e.g., tweeter) grille. While the pattern can be more complicated in three dimensions, as a result of the curvature of the grille as referred to above, in some cases an underlying regular/repeating pattern in two dimensions can be discerned from the three-dimensional pattern seen in practice. Such patterns, when mapped onto a 2-D surface, can be characterised by a tessellating pattern of identically shaped holes (e.g., each being a regular polygon). For example, FIG. 1 shows a pattern of square holes 4. It will be appreciated that in order for the holes 4 to be defined as separate shapes there is structure—in the form of the mesh 2 (e.g., in the case of FIG. 1 a metal wire mesh)—between the holes. As such the pattern may, in terms of its tessellating nature, be considered as being formed by a repeating tessellating cell 6 (drawn in broken lines and shown separately in FIG. 2) comprising a square hole. The mesh that forms the pattern may be made from a first set of parallel spaced apart wires that are interwoven with a second set of parallel spaced apart wires, extending in a direction perpendicular to those of the first set.

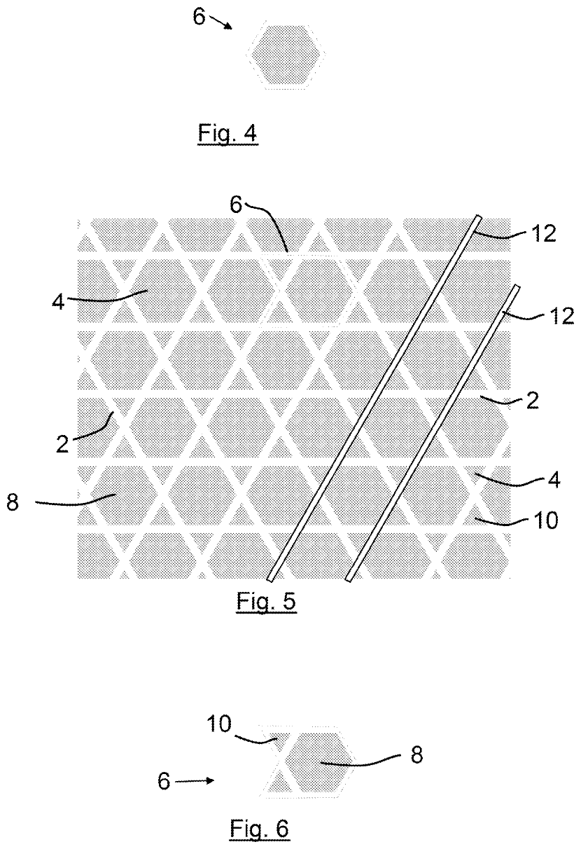

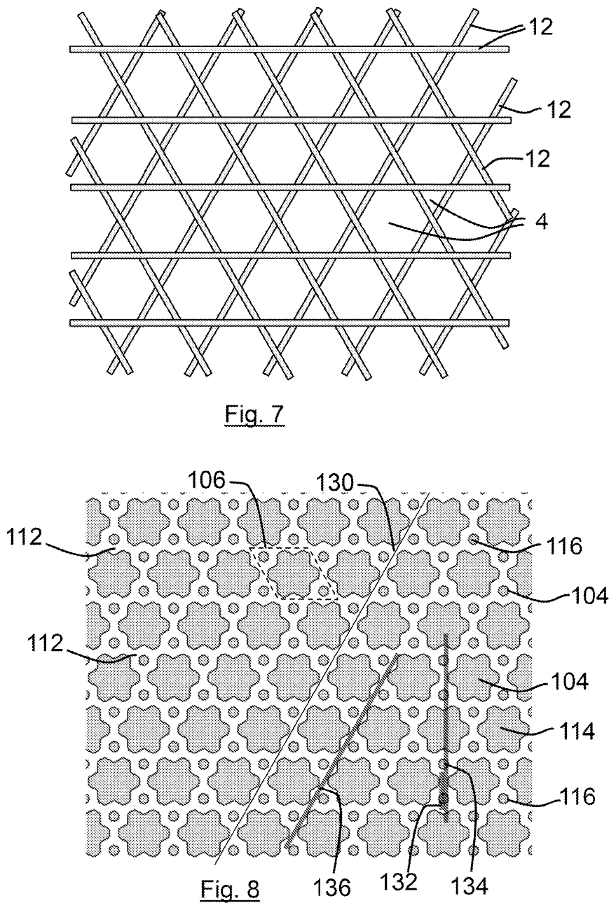

Another 2-D pattern of holes for a loudspeaker grille is shown in FIG. 3, which shows a mesh 2 and a pattern of hexagonal holes 4 formed by a repeating tessellating cell 6 (shown separately in FIG. 4) comprising a single hexagonal hole. The mesh that forms the pattern may be made from a flat sheet of metal that is etched or machined to remove material and form the desired pattern of holes. A further pattern is shown in FIGS. 5 and 6, which shows schematically the 2-D pattern of holes that feature on the tweeter grille used in the 800 Series Diamond™ loudspeakers (for example the 801D4 speaker) and also (albeit on a tweeter grille having a different 3-dimensional shape) on the tweeter grille used in the 600 Series Anniversary Edition loudspeakers (for example 606 S2 Anniversary Edition) all being made and sold by the company known as Bowers & Wilkins®). It will be seen that this pattern is formed by a repeating tessellating cell 6 (see FIG. 6) comprising a single hexagonal hole 8 and two smaller triangular holes 10. Similar to the patterns of FIGS. 1 and 3, the tessellating cells 6 tessellate in adjacent straight lines to form the pattern. The mesh 2 can be formed by etching holes 6 from a flat sheet, and then forming the desired 3-dimensional shape for the tweeter grille by deforming the flat sheet as required. The mesh 2 can be considered as having holes 4 formed by three separate sets of parallel spaced apart straight walls, such that the walls of one set are each at +/−60 degrees to each the walls of the other two sets. In the world of high-end hi-fi equipment there is always a desire to improve performance. At the very discerning end of the hi-fi market, relatively modest improvements in performance of one or more parts of a particular hi-fi set-up, as measured with scientific equipment, can result in markedly improved performance as judged by the human ear.

FIG. 8 shows a 2-D pattern of holes 104 for use on a tweeter grille 102 for a loudspeaker (e.g., a hi-fi loudspeaker), which can have a curved shape in 3 dimensions. The pattern of holes can be defined by a metal mesh. The metal mesh can be formed from a 0.5 mm thick carbon steel plate, by a process which includes creating a blank work-piece from the steel plate, and then etching away a 2-D pattern of holes in accordance with the 2-D pattern as shown in FIG. 8. Other thicknesses and other materials could be used. The plate can have a thickness of about 0.2 mm, about 0.3 mm, about 0.4 mm, about 0.5 mm, about 0.6 mm, about 0.7 mm, about 0.8 mm, about 0.9 mm, about 1 mm, or any values or range therebetween, although other configurations are possible. The work-piece is then deformed, and cut, to the desired 3-D shape, such as by stamping with a press (which may be a two-step process). Then the work-piece can undergo a coating process, which can include depositing a ~15 μm primer layer on each side of the work-piece, such as by using an electrophoretic deposition (ED) process, followed by spray painting on each side an outer layer of paint (wet sprayed) to a thickness of 20 μm +/−5 μm each side. The coatings may thus create a coated finish with a thickness of about 30 to 40 microns per side. Many variations are possible. For example, one or both of the primer layer and the paint layer can be omitted, or applied to only one side. The primer layer and/or the paint layer can have various suitable thicknesses, such as about 10 microns, about 15 microns, about 20 microns, about 25 microns, about 30 microns, or more, or any values or ranges between any of these values.

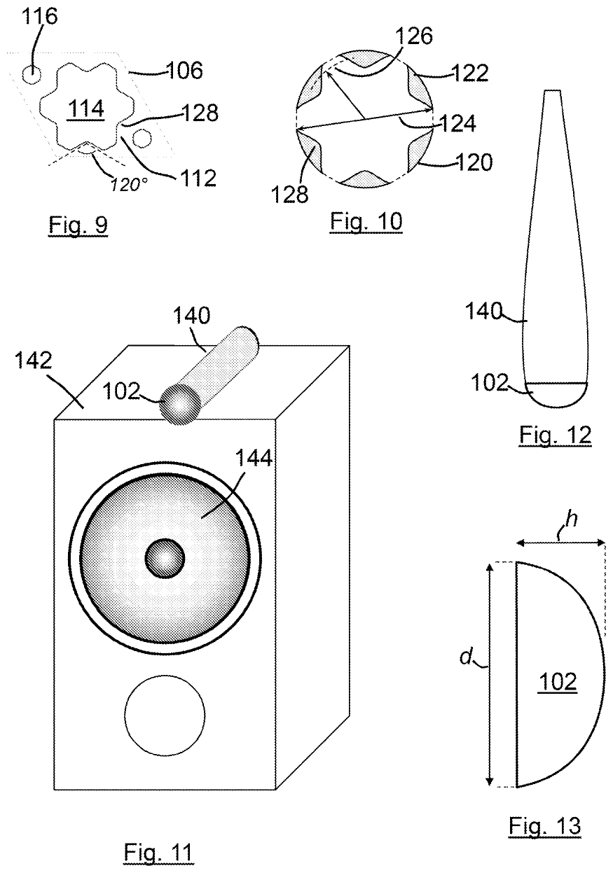

It will be seen from FIG. 8 that this example has a pattern of holes 104 formed by a repeating tessellating cell 106 (shown separately in FIG. 9). The cell 106 has a single larger hole 114 and two smaller holes 116. The cell is shown in FIGS. 8 and 9 as being diamond shaped, but could alternatively be formed by a differently shaped cell that tessellates (similar to the shape of the cell in FIG. 6 for example). The holes are separated by walls 112, that form the structure of the mesh. The tessellating cells 106 tessellate in adjacent straight lines to form the pattern, in this implementation. symmetry. In the example of FIGS. 8 and 9, the larger hole 114 has six-fold rotational symmetry, although other examples can have rotational symmetry that is three-fold, four-fold, eight-fold, or more. The larger hole 114 can have a shape which is close to that shown in FIG. 10, which shows a circle 120 from which there are removed six lens-shaped curved cut-outs 122. The larger hole 114 can have a minimum diameter of 1.9 mm and a maximum diameter (dimension 124) of about 2.5 mm (i.e. about 30% bigger). In some implementations, the larger hole 114 can have a dimension 124 across a widest portion of the opening that can be about 1 mm, about 1.2 mm, about 1.4 mm, about 1.6 mm, about 1.8 mm, about 2 mm, about 2.2 mm, about 2.4 mm, about 2.6 mm, about 2.8 mm, about 3 mm, or more, or any values or ranges between any of these sizes (e.g., between 1.8 mm and 2.6 mm). The dimension 124 can extend through a center of the larger opening 114. FIG. 10 shows an arc 126 drawn at a radius of 90% of half the maximum diameter. It will be seen that almost half (and certainly more than a quarter) of the perimeter of the hole is outside of the 90% radius distance. The shape of the larger hole 114 can have outer portions of the perimeter that are spaced away from a center of the larger hole 114 by more than a distance that is 90% of the maximum distance from the center to the periphery (e.g., outside of the arc 126 in FIG. 10). The outer portions of the perimeter can make up about 15%, about 20%, about 25%, about 30%, about 35%, about 40%, about 45%, about 50%, about 55%, about 60%, about 65%, about 70%, or more of the total perimeter length, or any values or ranges between any of these percentages, although other designs are possible.

The shape of the large hole 114 has 18 discernible substantially straight sides, six of which lie substantially on the circumference of the notional circle with a diameter of the maximum diameter. The other twelve sides are divided into six pairs, each pair of sides meeting inwardly of the notional circle at an angle of about 120 degrees, thus forming six concave regions 128. The corners at which adjacent sides meet are each rounded with a radius of curvature between about 0.1 mm and about 0.2 mm (e.g., of about 0.15 mm). Many variations are possible, such as shapes similar to FIG. 10, but with four, five, eight, ten, twelve, or more concave regions.

The smaller holes 116 can be round. The smaller holes 116 can be in the form of rounded hexagons. In some cases, the smaller holes 116 can be close to being circular. In some implementations, any corners in the holes 114, 116 that would otherwise be defined by two straight edges meeting at an angle, are formed by round of about 0.15 mm). The larger hole 114 can have a diameter or width between about 1 mm to about 3 mm (e.g., of about 2.5 mm), whereas the smaller holes 116 can have a diameter or width between about 0.2 mm and about 1 mm (e.g., of about 0.5 mm). The width of the walls that separate the holes from each other can have a width between about 0.2 mm or about 0.4 mm and about 1 mm (e.g., of about 0.5 mm, although narrower wall widths may be possible with stronger materials and/or greater thickness). As a result, the percentage of open area defined by the mesh can be about 60% (in the embodiment of FIGS. 8-10 around 58%). In other configurations, the open area defined by the mesh can be about 40%, about 45%, about 50%, about 55%, about 60%, about 65%, about 70%, about 75%, about 80%, or any values or ranges between any of these percentages, although other design are possible. The total area of the tessellating cell is about 8 mm². The total area of the mesh is about 4,000 mm² and the pattern of holes covers most (>75%) of this area. There are therefore about 500 tessellating cells, which equates to about 1,500 holes in the mesh. There may therefore be a line of say between 15 and 40 big holes (e.g. ~25) as counted from one side of the grille (at the periphery of the pattern) to an opposite side, across a diameter of the grille. Other cell sizes, mesh sizes, and grille sizes can be used.

As best seen in FIG. 8, each larger hole 114 may be considered as being surrounded by six smaller holes 116 and each smaller hole 116 may be considered as being surrounded by three larger holes 114 directly next to it. The smaller holes 116 are convex shapes, and thus have a convex portion that faces the closest concave region of each larger hole 114 next to it. It will also be seen from FIG. 8, that four notional lines have been drawn, including a thin line 130 at 30 degrees to the vertical that is wholly contained within the boundaries of the walls between the holes, and three semi-transparent thick lines 132, 134, 136 each having a thickness of about 0.25 mm (about half the thickness of the wall) 112. Lines 132 and 134 are drawn next to each other and are vertical and show that, side-by-side, they span the distance between adjacent large holes 114. Line 136 is drawn parallel to thin line 130 and shows that it is not possible to position a straight line of constant width of 50% (let alone 75%) of the width of the wall such that it is wholly contained within the boundaries of a wall. Even at 50% thickness, the line 136 clips the sides of various holes 104. This is because the walls 112 that define the shapes of the holes are not straight and thus deviate from a straight line as they extend from one tessellating cell 106 to the next. The pattern can be configured so that a line having a thickness over a threshold amount cannot extend between the arrangement of or 116. The threshold thickness can be about 30%, about 35%, about 40%, about 45%, about 50%, about 55%, about 60%, about 65%, about 75%, or more of the thickness of the wall 112 or of the distance between adjacent holes, or any value or ranges between any of those percentages, although other designs are also possible.

The mesh with the pattern of FIG. 8 was formed into a tweeter grille 102 for use on a 805 D4 loudspeaker of the 800 Series Diamond™ loudspeakers from Bowers and Wilkins. Using the mesh to form such a grille included gluing a plastic retention ring mechanism to the metal mesh. The finished grille has a 3-D shape. The 2-D pattern shown in FIG. 8 is deformed when the stamping process stretches the 2-D work piece into the desired 3-D shape by the stamping process. The pattern of holes in 3-D is therefore different from the 2-D pattern as a result of this deformation. In order to discern a 2-D pattern formed by a repeating tessellating cell of holes, each cell being identically shaped, the 3-D pattern of holes as seen in the 3-D mesh of the grille can be notionally projected onto a flat 2-D surface in such a way as to reverse the deformation caused by the deformation (e.g., stamping).

The 805 D4 speaker (shown schematically in FIG. 11) is a 2-way loudspeaker designed for being mounted on a stand and has a 25 mm tweeter housed in its own unit 140 which is mounted on top of the front-ported enclosure 142 that houses the single midrange/bass driver unit 144. The tweeter unit 140 is shown in plan view in FIG. 12, which shows the tweeter grille 102 mounted to the front of the unit. The dome shape of the tweeter grille can be seen separately in FIG. 13. The dome has a diameter d of about 60 mm and a height h of about 20 mm. Various other sizes and configurations of grilles can be used, such as depending on the driver being covered.

Comparisons were made between a 805 D4 loudspeaker with a tweeter grille according to the first embodiment (e.g., using the pattern of FIG. 8) and the same speaker but fitted with a tweeter grille made from a mesh etched using a pattern as shown in FIGS. 5 and 6, and then stamped and coated/painted in the same manner as the present embodiment. Before coating/painting, the area of the smaller holes of the mesh using the pattern of FIG. 5 were about 25% bigger than the smaller holes of the mesh using the pattern of FIG. 8, the area of the larger holes of the mesh using the pattern of FIG. 5 were about 0.5% smaller than the larger holes of the mesh using the pattern of FIG. 8, and the wall widths were about the same, with the result that the open area as a the pattern of FIG. 5 than for the mesh using the pattern of FIG. 8.

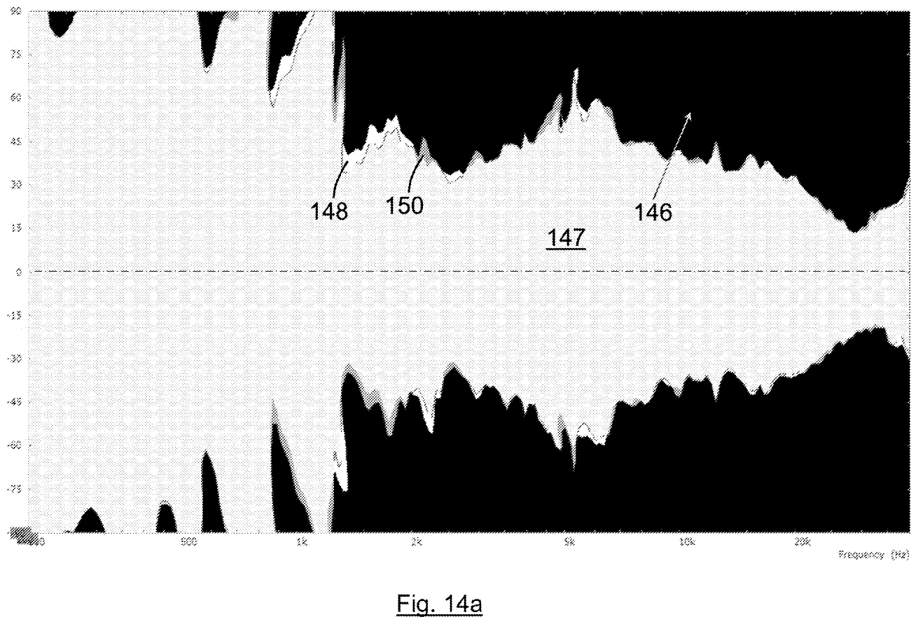

First, some objective tests were made including a comparison of the frequency response of loudspeaker with the grille using the pattern of FIG. 8 and the grille using the pattern of FIG. 5. The measurements of frequency response were conducted in an anechoic chamber, which approximates free field conditions, meaning no or minimal reflections from the walls, ceiling, or floors. That leads to discrimination of room influence on the measurements above a certain cut-off frequency—in this case around 100 Hz. Measurements of frequency response of the system were taken to produce directivity maps showing frequency response with respect to different angles of radiation. Measurements were taken in the front half sphere at 5 degree intervals in the horizontal plane (with 0 degrees being the on-axis response) from −90 degrees to +90 degrees at a distance of 1.65m from the tweeter dome front face. All measurements were taken at the same vertical height, that being level with the mid-point of the tweeter dome. The results are shown in the graphs of FIGS. 14a to 18.

FIG. 14a is a −6 dB frequency response contour plot with frequency along the horizontal axis (as a logarithmic scale from 200 Hz to 40 kHz) and angle along the vertical axis (as a linear scale from −90 degrees to +90 degrees). The diagram shows four −6 dB contours, one on either side of the 0 degrees position for the grille using the pattern of FIG. 5, showing where the frequency response drops off by −6 dB, and a corresponding contour on either side for the embodiment that uses the pattern of FIG. 8, all being normalised to 0 deg. The black region 146 is the boundary on one side with the closest of the two −6 dB contours, whereas the light grey region 147 is the boundary for the other of the two −6 dB contours. The regions where the FIG. 5 mesh drops off at a wider angle than the FIG. 8 mesh are shown by white shading 148, whereas the regions where the FIG. 8 mesh drops off at a wider angle than the FIG. 5 mesh is shown in dark grey shading 150. This shows that the grille using the pattern of FIG. 8 has a better symmetry of response with respect deviation from the 0 degree listening position (on-axis) as compared to the grille that used the pattern of FIG. 5.

FIG. 14b is a contour plot for −1.76 dB drop-off comparing the designs according to the grille using the pattern of FIG. 8 (solid lines) and the similar grille that uses the pattern of FIG. 5 (dashed lines). It will be seen that when looking at 1.315 kHz (within the region of peak sensitivity of the average listener), the deviation between left and right listening positions for the FIG. 8 pattern (being about 1 degree significantly reduced as compared to using the pattern of FIG. 5 (being about 6 degrees—the difference in height of the double-headed arrows drawn in dashed line). Ideally the contour plots for left and right of the 0 degree position, would be symmetrical so that there is zero deviation.

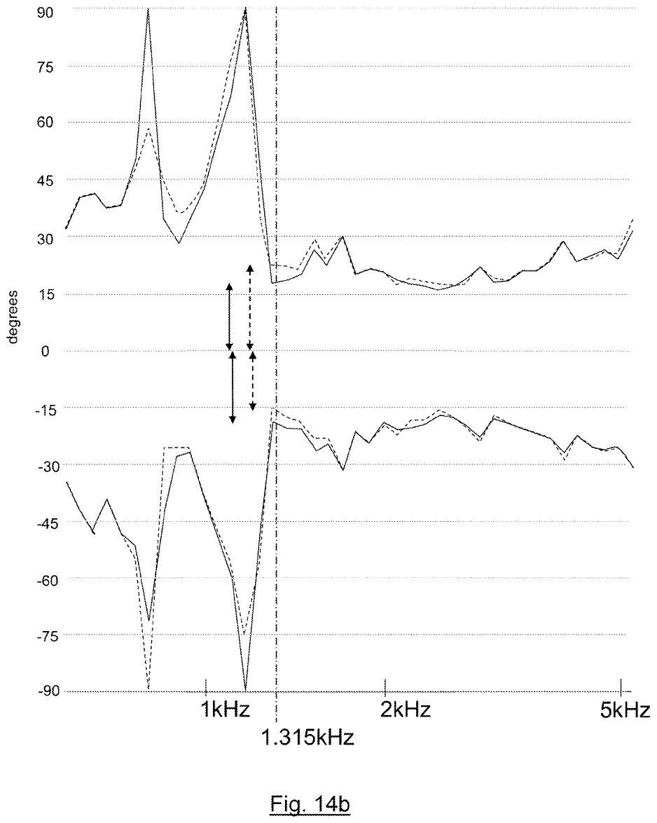

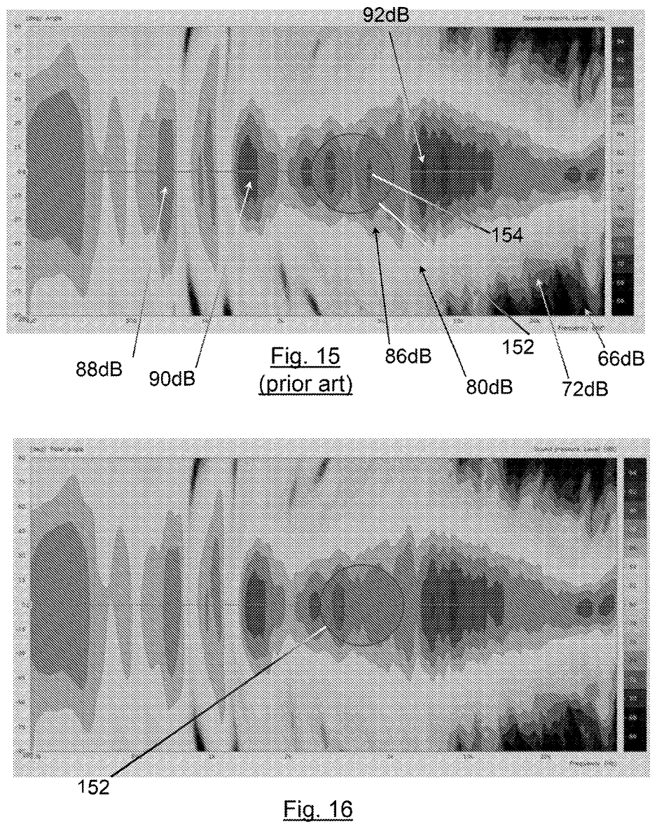

FIGS. 15 and 16 are frequency response plots for the grille using the pattern of FIG. 5 (FIG. 15) and for the grille using the pattern of FIG. 8 (FIG. 16). The contour plots are of sound pressure (different shades of grey showing a graduation from 66 dB to 94 dB) according to frequency (along the horizontal axis, which is a logarithmic scale from 200 Hz to 40 kHz) and angle (along the vertical axis, which is a linear scale from −90 degrees to +90 degrees). It will be seen that around the 4 kHz region (the region marked by the circles 152 in FIGS. 15 and 16) where human hearing is most sensitive, there is a slight dip (loss of energy) in the frequency response present in the FIG. 5 pattern (see the region of 86 dB between the two regions of 88 dB at 0 degrees within the circled area 152 in FIG. 15) that is filled in the corresponding frequency response in the embodiment (note the absence of any dip from the 88 dB region along 0 degrees within the circled area 152 in FIG. 16). There is also a smoother response visible in dispersion as well as in on axis and power spectrum responses (compare FIG. 16 with FIG. 15). Also 4.7 kHz peak 154 (observed in FIG. 15) present in the FIG. 5 pattern is attenuated, with improving smoothness and tonal balance in that region in the embodiment that uses the pattern of FIG. 8 (absence of peak in FIG. 16).

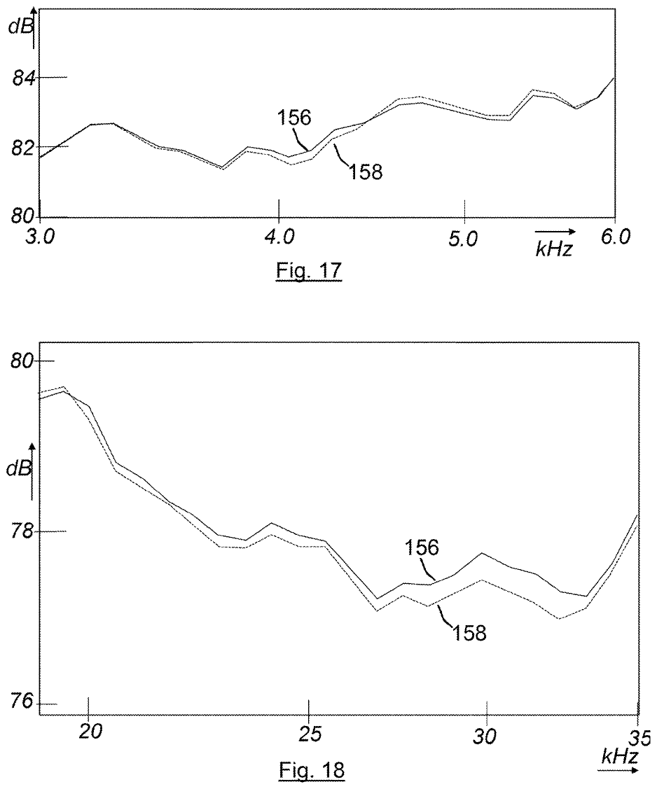

FIG. 17 is power spectrum plot from 3 kHz to 6 kHz averaged over all measured angles which compares the performance of the embodiment using the pattern of FIG. 8 (solid line 156) with the performance of the pattern of FIG. 5 (dashed line 158). The performance of the embodiment using the FIG. 8 pattern can clearly be seen to be smoother and the embodiment using the FIG. 8 pattern boosts levels between 3.8-4.4 kHz by around 0.2 dB. FIG. 18 is a similar graph to FIG. 17 but showing the power spectrum plot at higher frequencies, from 20 kHz to 35 kHz which are typically considered to be outside the normal range of hearing when sound only contains energy at those frequencies or higher, but nevertheless important for quality of audio reproduction at the high end of the normal range of hearing. Again, the performance of the embodiment using the pattern of FIG. 8 is shown with a solid line 156 and the performance of the version using the pattern of FIG. 5 is shown with a dashed line 158). The embodiment using the pattern of FIG. 8 boosts sound levels by up to 0.3 dB frequencies.

The grille embodiment that uses the pattern of FIG. 8 thus performs better when assessed objectively in comparison to a grille that uses the pattern of FIG. 5, which does not have holes with concave regions facing convex shaped holes. The grille that uses the pattern of FIG. 5 having a pattern of holes formed (in 2-D) by three sets of parallel straight line walls each at 60 degrees to the others.

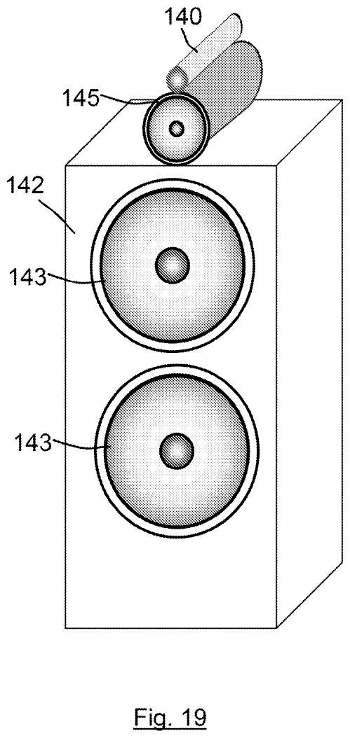

Listening tests were also performed to compare the performance of the embodiment that uses the pattern of FIG. 8 with that of the version that uses the pattern of FIG. 5. The listening tests were conducted by a panel of trained as well as inexperienced listeners on multiple occasions to rate the perceivable qualities of the tweeter grille of the embodiment versus the prior art design. In this case, the comparison was done using a pair of 801 D4 loudspeakers from Bowers and Wilkins each with a tweeter grille according to the embodiment that uses the pattern of FIG. 8 and the same pair of speakers but fitted with a tweeter grille that uses the pattern of FIG. 5, the tweeter grilles used being of the same types as used in the objective comparisons. A schematic representation of the 801 D4 loudspeaker is shown in FIG. 19. The speaker is a 3-way bass reflex speaker having a main floor standing enclosure 142 in which there are two 10 inch (25 cm) woofers 143, and on top of which there is a single 6 inch (15 cm) midrange unit 145 housed in a separate housing (referred to as a “turbine head” by Bowers and Wilkins), on top of which there is mounted a 1-inch (25 mm) tweeter housed in its own unit 140. The listening environment was an acoustically adapted listening room. Additional listening sessions were also conducted by trained listeners on products from the 700S3 series that utilizes the “tweeter on top” arrangement.

There was good evidence from the listeners that the embodiment using the pattern of FIG. 8 performed better than the version using the pattern of FIG. 5, bringing an overall improved sound quality described by listeners as:
Improved clarity of the whole audible spectrum.
Lower noise floor leading to improved resolution in the top end.
More ‘air’ leading to deeper perceived sound stage (also linked to low noise floor).
Improved imaging of sources in the sound stage.
Wider perceived sound stage. perception of instruments. Sound was more ‘alive’.
Improved overall tonal balance.
Less fatiguing, easier to listen to for longer periods of time.

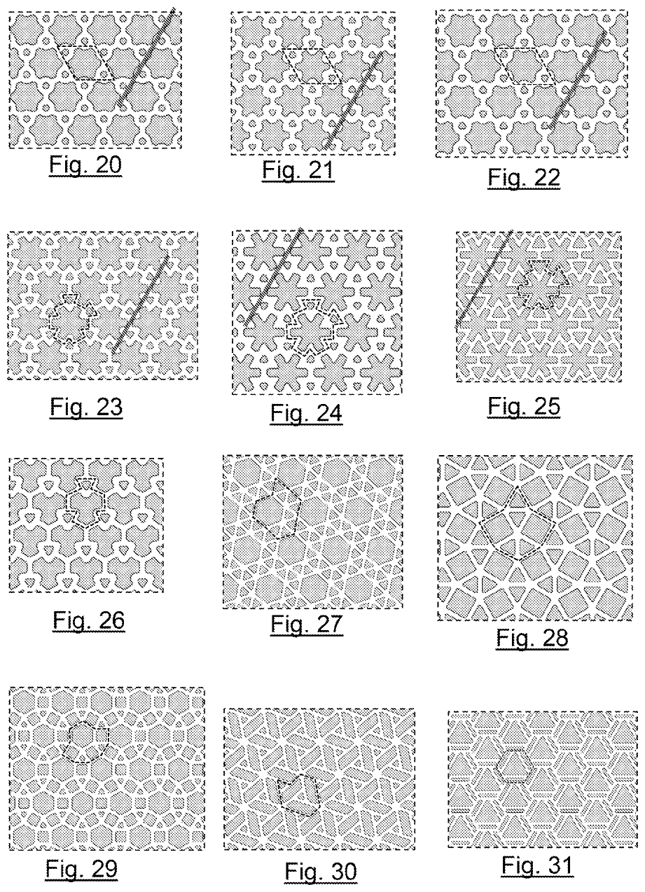

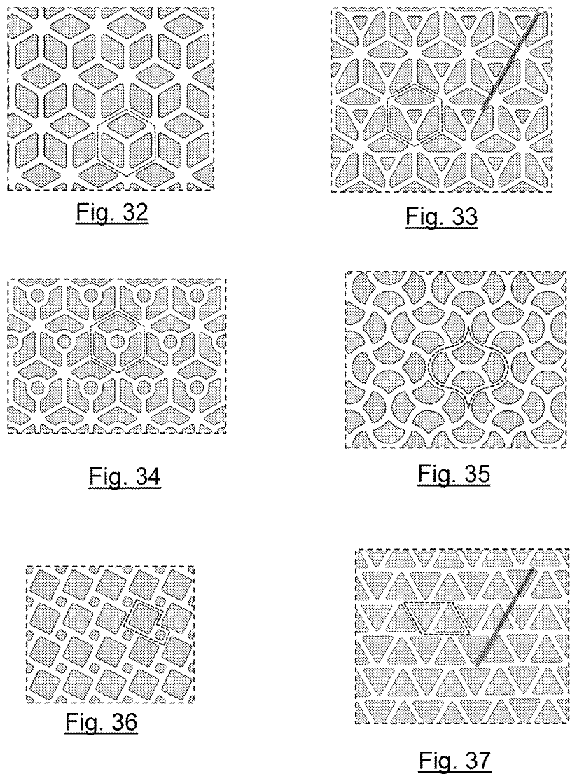

Experiments were conducted to assess whether other patterns of holes having the features of (a) large holes with multiple concave regions each of which being paired with a smaller convex hole and/or (b) holes being defined by walls that deviate from a straight line in a least one major direction of wall. Such other patters are shown in FIGS. 20 to 37. In each Figure the tessellating cell is outlined with a dashed line and in some Figures a semi-transparent line is drawn with a thickness of about 75% of the wall thickness to show that the walls are non-linear in a certain direction (where that might not be self-evident). Thus it will be observed that the patterns of FIGS. 20 to 26, 34 and 35 are each formed by a repeating tessellating cell having a hole with a convex region that faces a concave region of another hole. FIGS. 27 to 33 and 36 and 37 do not have this feature however. It will be observed that the patterns of all of FIGS. 20 to 37 are defined by non-linear walls (e.g. such that it is not possible to identify or draw straight lines at three different angles and within the boundaries of the walls with each straight line both having a constant width of 75% of the wall width and extending completely through at least three cells). The better performing patterns, according to the subjective tests, tended to be more similar to the FIG. 8 pattern (e.g., FIGS. 20 to 23) but also included the patterns of FIGS. 27, 29, 32, 34, 35 and 37. FIGS. 32, 35 and 37 are worth noting because they each comprise only one shape of hole but the tessellating cell includes the same shape (and the same size) in three different orientations (FIG. 32), in four different orientations (FIG. 35), and in two different orientations (FIG. 37). FIG. 36 has a cell in which the two holes are the same shape and the same orientation but are different sizes.

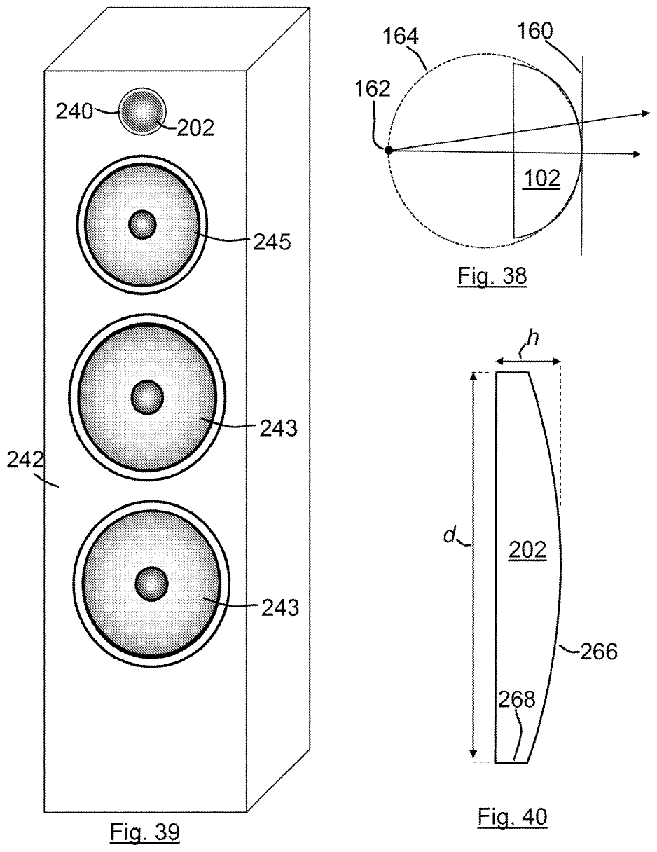

It will be appreciated that the apertures (corresponding to the holes) in the 3-D grille are defined by the mesh that surrounds the apertures (holes). The mesh may be considered as being formed solely by walls, the walls being what defines the apertures (holes). In three-dimension, the tweeter grille will have walls and apertures (corresponding to the holes shown in FIGS. 8 and 20 to 37), but possibly with a slightly deformed shape as a result of the deformation that transforms the flat etched plate into a 3-D mesh shape). It may be self-evident that a 3-D mesh has been created using a certain 2-D pattern of tessellating cells of holes. The pattern of holes (and walls) is mostly the 2-D pattern of holes that forms a 3-D pattern of holes it may be necessary to use a projection of a 3-D pattern onto a notional flat surface. The projection may be a mathematical projection, used to transform a 3-D pattern into a 2-D pattern. In the case of a grille that is originally made by creating a regular pattern of holes onto a flat sheet, before then shaping (deforming, normally by stretching parts of the flat structure by different amounts) the flat sheet into a 3-D shape, the (mathematical, or otherwise) projection used to discern the properties of the 2-D pattern of holes may be one that reverses, as closely as possible, the deformation caused when physically shaping the 2-D sheet into the 3-D grille. In cases where there appears to be repeating patterns of apertures on the 3-D grille, extending over the grille along substantially parallel paths (in 3-D), with the number, layout, size, and orientation of apertures in one pattern being substantially the same as the next (albeit with minor differences as a result of the different local geometry of the 3-D shape of the grille), then the projection is preferably one that maps the pattern of apertures onto a flat 2-D surface such each pattern of apertures in 3-D is mapped onto an identically configured tessellating cell, with each cell having an arrangement of holes that corresponds to a stereographic projection of the pattern of apertures closest to the center of the grille. With reference to FIG. 38, the stereographic projection of the pattern of apertures closest to the center of the grille may be formed by projecting the 3-D pattern onto a 2-D plane 160 that is the tangent plane at the center of the front-facing surface (the surface that smoothly envelopes the front face of the mesh of the grille 102). The stereographic projection has a center of projection 162 that is perpendicularly rearward, of the point of intersection of the 2-D plane with the front-facing surface of the grille, by a distance equal to twice the radius of curvature of the front-facing surface at that point of intersection (e.g. the circle having that radius of curvature being shown in FIG. 38 with the dashed line 164).

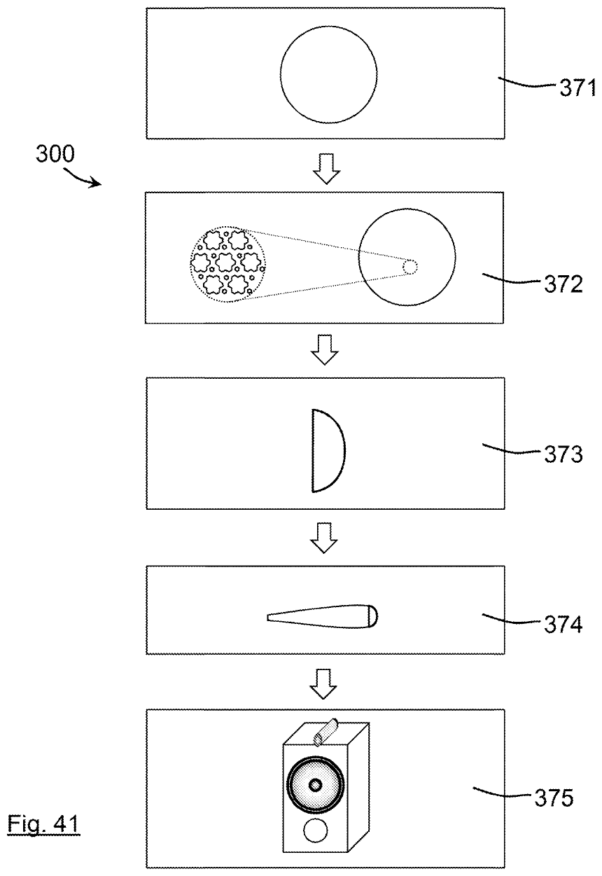

A further embodiment (20th embodiment) utilizes a tweeter grille 202 with a pattern of holes as shown in FIG. 8 but on a tweeter grille with a shallower profile and slightly smaller diameter. The tweeter grille 202 can be used on a speaker similar to the existing 603 S2 loudspeaker of the 600 Series Anniversary Edition loudspeakers from Bowers and Wilkins. The 603 speaker (shown schematically in FIG. 39) is a 3-way floor standing speaker with an enclosure 242 in which there are two woofers 243, a single midrange unit 245 and at the top a tweeter unit 240. The dome shape of the tweeter grille 202 of the tweeter unit 240 can be seen separately in FIG. 40. 266 with a radius of curvature of about 90 mm and a lip, in the form of a cylindrical flange 268 of depth 5 mm. In this case each large hole has a diameter of about 2.6 mm, whereas the small holes have a diameter of about 0.7 mm. The width of the walls that separate the holes from each other have a width of about 0.5 mm at its narrowest. There are at least, very approximately, about 800 holes in the mesh. In other embodiments that could be as many as, say, 1,000 holes in total or more. Various other grille sizes and configurations can be used.

FIG. 41 shows a flowchart illustrating a method of making a loudspeaker unit by a series of steps. The loudspeaker to be made is one which has a tweeter drive unit, having its own housing mounted on top of a loudspeaker enclosure (i.e. a “tweeter on top” arrangement). As a first step (represented by box 371), a flat sheet of metal is provided. This may have been cut to size in advance. Then as a next step (represented by box 372) a pattern of holes is etched from the sheet to form a pattern (e.g., like the one shown in FIG. 8). Then a step (represented by box 373) of bending the sheet of metal to form a 3-D dome is performed, in this case by stamping. Then there may need to be an extra step (not shown) of cutting around the edge (periphery) as required and/or one or more further shaping steps. There may also be steps of adding one or more coatings to the grille, to one or both sides (e.g. by electrophoretic deposition and/or spray painting). The grille is then fixed to the tweeter drive unit (the step represented by box 374). As mentioned above, the tweeter drive unit can have its own housing, which in this embodiment can include an aluminium machined body attached to which is a plastic bezel. As a preliminary part of this step 374, a retention ring can be glued to the metal mesh to create a tweeter grille assembly consisting of the metal mesh and the retention ring. This grille assembly can then be attached to the tweeter housing, with the grille assembly forming contact with the housing and the plastic bezel. The attaching of the grille assembly to the tweeter housing could be performed before or after fixing the tweeter unit to the rest of a loudspeaker enclosure (the step represented by box 375).

Whilst the present disclosure has been described and illustrated with reference to particular embodiments, it will be appreciated by those of ordinary skill in the art that the disclosure lends itself to many different variations not specifically illustrated herein. By way of example only, certain possible variations will now be described. periphery of the grille. There may for example be an annular rim free of such holes for example. Other shapes of grille may be used

The embodiments may have application in relation to grilles for other acoustic devices, such as speakers for televisions, laptops or the like, for headphones or ear-buds (with appropriate scaling) and or microphones.

The holes may be etched in 2-D with a pattern that includes some pre-distortion (in the pattern) so that when deformed to a 3-D shape the holes are more similarly shaped than they would otherwise be.

It is possible to form the 3-D shape of the grille and then etch away material to form a pattern of holes. It may also be possible to 3-D print a mesh with the desired pattern.

It may be that different metal materials and different coatings may be used. In some cases, it may be possible not to need a wet paint process, particularly if materials with higher corrosion resistance are used. An alternative metal material is ferritic stainless steel (e.g. grade 430) for example. In some cases, other materials such as non-metals could be used. The coating(s) on the product may be thicker than mentioned above and have a thickness of at least 50 microns per side. Other dimensions may be varied too.

The method shown in FIG. 41 may be adapted for tweeter drive units that are accommodated in the main loudspeaker housing (i.e. an arrangement in which the tweeter is mounted in the front baffle of the loudspeaker enclosure). In such a case, the grille mesh may be attached to a plastic bezel of the tweeter drive unit and there may then be a step of attaching a front-facing trim ring that surrounds the grille and fits in a gap that would otherwise exist between the periphery of the grille and the surrounding part of the front baffle of the enclosure.

Where in the foregoing description, integers, values, or elements are mentioned which have known, obvious or foreseeable equivalents, then such equivalents are herein incorporated as if individually set forth. It will also be appreciated by the reader that integers, values, or features of the disclosure that are described as preferable, advantageous, convenient or the like are optional and do not limit the scope of all embodiments of the disclosure. Moreover, it is to be understood that such optional integers, values, or features, whilst of possible benefit in some embodiments, may not be desirable, and may therefore be absent, in other embodiments. description and the claims, the words “comprise,” “comprising,” “include,” “including,” and the like are to be construed in an inclusive sense, as opposed to an exclusive or exhaustive sense; that is to say, in the sense of “including, but not limited to.” The words “coupled” or connected,” as generally used herein, refer to two or more elements that can be either directly connected, or connected by way of one or more intermediate elements. Additionally, the words “herein,” “above,” “below,” and words of similar import, when used in this application, shall refer to this application as a whole and not to any particular portions of this application. Where the context permits, words in the Detailed Description using the singular or plural number can also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values within a range of measurement error.

Although this disclosure contains certain embodiments and examples, it will be understood by those skilled in the art that the scope extends beyond the specifically disclosed embodiments to other alternative embodiments and/or uses and obvious modifications and equivalents thereof. In addition, while several variations of the embodiments have been shown and described in detail, other modifications will be readily apparent to those of skill in the art based upon this disclosure. It is also contemplated that various combinations or sub-combinations of the specific features and aspects of the embodiments may be made and still fall within the scope of this disclosure. It should be understood that various features and aspects of the disclosed embodiments can be combined with, or substituted for, one another in order to form varying modes of the embodiments. Any methods disclosed herein need not be performed in the order recited. Thus, it is intended that the scope should not be limited by the particular embodiments described above.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more prompting, whether these features, elements and/or steps are included or are to be performed in any particular embodiment. Any headings used herein are for the convenience of the reader only and are not meant to limit the scope.

Further, while the devices, systems, and methods described herein may be susceptible to various modifications and alternative forms, specific examples thereof have been shown in the drawings and are herein described in detail. It should be understood, however, that the disclosure is not to be limited to the particular forms or methods disclosed, but, to the contrary, this disclosure covers all modifications, equivalents, and alternatives falling within the spirit and scope of the various implementations described. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication.

The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including ambient temperature and pressure.

1. A grille for an acoustic transducer unit, the grille having an arrangement of apertures such that when projected onto a notional flat surface there is a pattern of at least 20 holes, wherein:
the pattern is formed by a repeating tessellating cell comprising at least one hole being a first shape and at least one hole being a second shape such that the second shape has a convex region that faces a concave region of the first shape, and
the tessellating cells tessellate in adjacent straight lines.

2. A grille according to claim 1, wherein the pattern includes walls such that adjacent holes in the pattern are separated from each other by one of the walls, which extend along a non-linear path between the holes.

3. A grille according to claim 2, wherein
the walls each have a minimum width and are so configured that it is not possible to identify three straight lines such that:
each straight line has a constant width being 75% of the minimum width of the wall,
each straight line extends completely through at least three cells,
each straight line is angled apart from each of the other two straight lines by more than 30 degrees, and
each straight line is wholly contained within the boundaries of a wall.

4. A grille according to any preceding claim, wherein the first shape has a first area and the second shape has a second, smaller, area.

5. A grille according to any preceding claim, wherein the first shape has a first orientation and the second shape has a second different orientation or is a different shape.

6. A grille for an acoustic transducer, the grille comprising:
a mesh having an arrangement of apertures arranged such that when projected onto a notional flat surface there is a pattern formed by a repeating a tessellating cell that comprises at least one hole having a first shape and at least one hole having a second first shape.

7. The grille of claim 6, wherein the tessellating cells tessellate in adjacent straight lines.

8. The grille of any one of claims 6 to 7, wherein the pattern includes a plurality of walls such that adjacent holes in the pattern are separated from each other by one of the plurality of walls, which extend along a non-linear path between the holes.

9. The grille of claim 8, wherein:
the plurality of walls each having a minimum width and extending along a path between the holes, such that it is not possible to identify a straight line such that:
the straight line has a constant width that is 75% of the minimum width of the wall;
the straight line extends completely through at least three of the tessellating cells; and
the straight line is wholly contained within the boundaries of the wall.

10. The grille of claim 8, wherein:
the plurality of walls each have a minimum width and are so configured that it is not possible to identify three straight lines such that:
each straight line has a constant width being 75% of the minimum width of the wall,
each straight line extends completely through at least three cells,
each straight line is angled apart from each of the other two straight lines by more than 30 degrees, and
each straight line is wholly contained within the boundaries of a wall.

11. A grille according to any one of claims 6 to 10, wherein the first shape has a first area and the second shape has a second area that is smaller than the first area.

12. A grille according to any one of claims 6 to 11, wherein the first shape has a first orientation and the second shape has a second different orientation.

13. A grille according to any one of claims 6 to 12, wherein the second shape has a different shape than the first shape.

14. A grille for an acoustic transducer unit, the grille having an arrangement of apertures such that when projected onto a notional flat surface there is a pattern of at least 20 holes, wherein:
the pattern is formed by a repeating tessellating cell comprising at least one hole being a first shape having a first area and a first orientation and at least one hole being a second shape having a second area and a second orientation such that at least one of the shape, size and orientation of the first shape is different from the corresponding shape, size and orientation of the second shape,
the tessellating cells tessellate in adjacent straight lines,
the pattern includes walls such that adjacent holes in the pattern are separated from each other by one of the walls, the walls each having a minimum width and extending along a non-linear path between the holes, such that it is not possible to identify three straight lines such that:
each straight line has a constant width being 75% of the minimum width of the wall,
each straight line extends completely through at least three cells,
each straight line is angled apart from each of the other two straight lines by more than 30 degrees, and
each straight line is wholly contained within the boundaries of a wall.

15. A grille for an acoustic transducer, the grille comprising:
an arrangement of apertures such that when projected onto a notional flat surface a pattern is formed by a repeating tessellating cell comprising at least one hole being a first shape having a first area and a first orientation and at least one hole being a second shape having a second area and a second orientation such that at least one of the first shape, first area, and first orientation of the first shape is different from the corresponding second shape, second area and second orientation of the second shape; and
walls such that adjacent holes in the pattern are separated from each other by one of the walls, the walls each having a minimum width and extending along a path between the holes, such that it is not possible to identify a straight line such that:
the wall;
the straight line extends completely through at least three of the tessellating cells; and
the straight line is wholly contained within the boundaries of the wall.

16. The grille of claim 15, wherein the tessellating cells tessellate in adjacent straight lines.

17. The grille of any one of claims 15 to 16, wherein the walls are configured such that it is not possible to identify three straight lines such that:
each straight line has a constant width being 75% of the minimum width of the wall,
each straight line extends completely through at least three cells,
each straight line is angled apart from each of the other two straight lines by more than 30 degrees, and
each straight line is wholly contained within the boundaries of a wall.

18. A grille according to any preceding claim, wherein the tessellating cells tessellate in adjacent straight lines, such that the cells are staggered as between adjacent lines.

19. A grille according to any preceding claim, wherein the first shape has six fold symmetry.

20. A grille according to any preceding claim, wherein the first shape has at least three concave regions, each of which face a corresponding convex region of the second shape in the pattern.

21. A grille according to any preceding claim, wherein each cell comprises at least three holes.

22. A grille according to any preceding claim, wherein the grille is made from a sheet of material with a thickness in the range from about 0.1 mm to about 2 mm. of material with a thickness in the range from about 0.2 mm to about 1 mm.

24. A grille according to any preceding claim, having a maximum dimension of less than about 100 mm.

25. A grille according to any preceding claim, wherein the grille is dome-shaped and the center of the dome coincides with a hole of the first shape.

26. A grille according to any preceding claim, wherein the hole of the first shape has a minimum diameter and a maximum diameter, which is no more than about 50% bigger than the minimum diameter.

27. A grille according to any preceding claim, wherein the hole of the first shape has a maximum diameter corresponding to a maximum radial distance from a center of the hole, and a perimeter, and at least about 20% of the length of the perimeter is at a distance of at least about 90% of the maximum radial distance from the center of the hole.

28. A grille according to any preceding claim, wherein the grille is a grille for a tweeter loudspeaker and has a diameter of between about 30 mm and about 100 mm.

29. A method of making a loudspeaker grille comprising bending or otherwise deforming a sheet of metal to form a dome-shaped region, the sheet of metal in which a pattern of at least 20 holes are formed, the pattern being in accordance with the pattern of at least 20 holes referred to in any preceding claim.

30. A loudspeaker drive unit to which is attached a grille according to any of claims 1 to 28.

31. A loudspeaker drive unit according to claim 30, wherein the loudspeaker drive unit is a hi-fi tweeter drive unit.

32. A hi-fi loudspeaker comprising a drive unit according to claim 30 or 31.
drive unit is a tweeter drive unit that has its own body which is mounted on top of a separate enclosure of the loudspeaker which houses one or more of a midrange loudspeaker driver and a bass loudspeaker driver.
